(19) United States
(12) Patent Application Publication
(10) Pub. No.: US 2016/0037291 A1
(43) Pub. Date: Feb. 4, 2016

(54) PLACE OF RELEVANCE DETERMINATION IN A CELLULAR NETWORK

(71) Applicant: QUALCOMM Incorporated, San Diego, CA (US)

(72) Inventors: Shankar SADASIVAM, San Diego, CA (US); Jin Won LEE, San Diego, CA (US)

(21) Appl. No.: 14/450,856

(22) Filed: Aug. 4, 2014

(51) Int. Cl. H04W 4/02

(52) U.S. Cl. CPC H04W 4/02; H04W 84/042

(57) ABSTRACT

A method includes receiving cellular network signals at a mobile device from several cells of a cellular network. The method then includes generating a place model representative of a characteristic of the place where the mobile device is located in response to the received cellular network signals. In one aspect, the place model is clustered with one or more previously generated place models if the place model is similar to the one or more previously generated place models. In another aspect, it is determined whether the place where the mobile device is located is a place of relevance to a user based on the clustering of one or more previously generated place models if the place model is similar to the one or more previously generated place models.

### TECHNICAL FIELD

This disclosure relates generally to mobile communications and, in particular but not exclusively, relates to determining whether a current position of a mobile device in a cellular network is a place of relevance to the user.

### BACKGROUND INFORMATION

The penetration of smart phone devices in the wireless handset market has increased dramatically in recent years. Along with touch screens that facilitate the use of a broad range of applications, these devices are packed with sensors such as accelerometers, light and proximity sensors, Bluetooth and Wi-Fi radios, GPS, a microphone, etc. These sensors can be leveraged to collect contextual data about the user's actions and surroundings. This data provides an opportunity for mobile devices to become truly smart devices by gaining the ability to understand and leverage the context to intelligently enhance the user experience. Examples of such enhancements are personalization of user interaction (e.g., by adapting the interaction due to preferences) or altering the interaction based on the user context (e.g., adapting the interaction model, modality, or content based on the activity or situation of the user). Moreover, as devices are typically within close proximity to the user, context is available on demand, which is not the case for other computing platforms. Devices could automatically learn to adapt properties based on the situation or activity of users such as “put device on vibrate at dinner” or “enable Bluetooth when leaving home”. This illustrates how user behavior models (e.g. preferences of the user) in combination with contextual awareness (e.g. at a restaurant, in a meeting, or in a conversation) can be combined to enhance the user experience. This opens the flood gates to a range of potential applications that enhance the user experience.

A step towards truly smart devices is context awareness. In one aspect “context awareness” refers to any information that can be used to characterize the situation of the user. Context awareness may allow the discovery of answers to one or more of the following questions: (1) What is the user doing?; (2) What environment are they in?; (3) Where are they?; and (4) What are their intentions? Contextual awareness is inherently dependent on two things: (a) discovery of relevant states; and (b) recognition of state occurrences (e.g. motion states, device positions, places, ambiences, or activities). In one aspect, a system can be still be context aware even if the human is in the loop providing support in discovery, recognition, or both. For example, some location-based services rely on humans to discover relevant states (places), e.g. annotating relevant places on a map, and provide the ability to recognize state occurrences (revisits). Systems based on motion-states or based on ambience states are further examples where the state discovery is often supervised by humans and the ability of recognition provided by the system.

One type of context is the place of a user. A “place” may refer to a physical location with some regional expansion. In terms of the regional expansion, notions of a macro place may be differentiated from those of a micro place. A macro place refers to a place on the level of buildings or blocks, e.g. home, work, mall, or park, while a micro place refers to a place on the level of rooms, e.g. living room, office, men's section in a department store. The relevance of a place often depends on the activity and intent of a user. A relevant place to a user might be the restaurant at which a user has dinner. However, the same restaurant might not be a relevant place at all times. Consider the same user passing by the restaurant going for a walk. The restaurant may not longer be relevant as it is not semantically meaningful with respect to the current activity, namely going for a walk. Identifying which places are relevant is a very challenging problem and difficult to define without a specific application or use case in mind.

Furthermore, typical methods of determining the position of a mobile device consume relatively large amounts of power, which can limit their sustained use. For example, a GPS-based positioning system requires dedicated circuitry be enabled to detect, receive, and process timing signals sent by GPS satellites high above the earth. In another example, triangulation-based positioning systems require active communication with one or more cellular base stations to obtain base station positions and/or reference signal timing information.

### BRIEF SUMMARY

Accordingly, embodiments of the present disclosure include a system and method for determining whether a current position of a mobile device is a place of relevance to the user in a low-power manner. In one aspect, the method includes using readily available information in the mobile device obtained from the cellular network, without the need for additional communication with a base station. For example, the serving and neighboring base station IDs and RSSI information may be readily available in the modem stack, which is updated regularly by the mobile device. This information (i.e., the base station IDs and RSSI) may then be used to build statistical models for determining whether the mobile device is at a place of relevance with relatively very low power consumption.

For example, according to one aspect of the present disclosure, a method for building a database of clustered place models includes receiving cellular network signals from a plurality of cells of a cellular network at the mobile device while the mobile device is located at a place within the cellular network. A place model is then generated that is representative of a characteristic of the place where the mobile device is located based on the received cellular network signals. The method then includes clustering the place model with one or more previously generated place models if the place model is similar to the one or more previously generated place models.

A mobile device is provided in one aspect of the present disclosure. The mobile device includes a receiver that is configured to receive cellular network signals from a plurality of cells of a cellular network. The mobile device also includes memory and a processing unit that is configured to receive cellular network signals from a plurality of cells of a cellular network while the mobile device is located at a place within the cellular network. The processing unit is also configured to generate a place model that is representative of a characteristic of the place where the mobile device is located based on the received cellular network signals. The processing unit then clusters the place model one or more previously generated place models if the place model is similar to the one or more previously generated place models.

According to another aspect of the present disclosure, a method may include determining whether a current place where a mobile device is located is a place of relevance (POR) to a user of the mobile device. For example, the method may include receiving cellular network signals from a plurality of cells of a cellular network at the mobile device while the mobile device is located at a place within the cellular network. The method then includes generating a place model representative of a characteristic of the place where the mobile device is located in response to the received cellular network signals and determining whether the place where the mobile device is located is a place of relevance to a user based on a clustering of similar previously generated place models.

Another mobile device is provided in yet another aspect of the present disclosure. The mobile device includes a receiver configured to receive cellular network signals from a plurality of cells of a cellular network. The mobile device also includes memory and a processing unit that is configured to generate a place model representative of a characteristic of the place where the mobile device is located in response to the received cellular network signals and to determine whether the place where the mobile device is located is a place of relevance (POR) to the user based on a clustering of similar previously generated place models.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a functional block diagram of an example mobile device including a place of relevance module.

FIG. 2 is a functional block diagram of a place of relevance module for use in a mobile device.

FIG. 3A is a flowchart illustrating a process of building a database of clustered place models for use in a system of determining places of relevance.

FIG. 3B is a flowchart illustrating a process of determining whether a current place of a mobile device is a place of relevance.

FIG. 4 is a flowchart illustrating a process of building/updating a database of clustered place models and of determining whether a current place of a mobile device is a place of relevance.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

Following is a list of some of the terminology used herein and example definitions:

A “place” is a physical location with some spatial expansion. A place may be either a macro places or a micro place.

A “macro place” refers to a place with a spatial expansion at the level of a building, e.g. home, work, park, or mall.

A “micro place” refers to a place with a spatial expansion at a room level, e.g. office, living room, or a section in a store.

A “visit” is an interval of time during which a user remains continuously at the same place.

A “place of relevance” or “POR” is a place a user has visited a minimum number of times and where each of those visits exceeded a minimum duration of time.

A “revisit” is a visit to a known POR.

A “place model” captures the characteristic of a place. These characteristics are extracted from the underlying data collected at a place and are used to identify the corresponding place. A place model may be one of the following: a POR place model, a visit place model, and an instantaneous place model. In one aspect, each of these place models are similar in how the place is modeled.

The “POR place model” or “PPM” is used to characterize a POR.

The “visit place model” or “VPM” is used to characterize a visit.

The “instantaneous place model” or “IPM” is derived from instantaneously collected data and captures the characteristic of the current location or position of the user. The instantaneous place model is usually based on one or more data points.

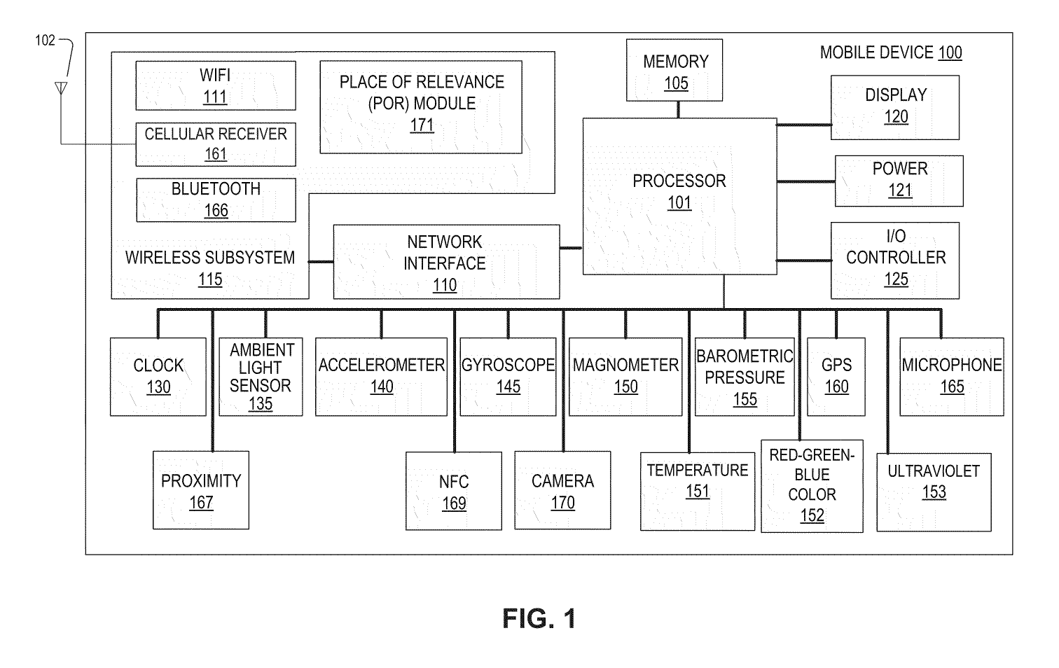

FIG. 1 is block diagram illustrating an example mobile device 100. Mobile device 100 may include one or more processors 101 (e.g., a general purpose processor, specialized processor, or digital signal processor), a memory 105, I/O controller 125, and network interface 110. Mobile device 100 may also include a number of device sensors coupled to one or more buses or signal lines further coupled to the processor(s) 101. It should be appreciated that device 100 may also include a display 120, a user interface (e.g., keyboard, touch-screen, or similar devices) (not shown), a power device 121 (e.g., a battery), as well as other components typically associated with electronic mobile devices.

Mobile device 100 optionally includes additional sensors such as a clock 130, ambient light sensor (ALS) 135, accelerometer 140, gyroscope 145, magnetometer 150, temperature sensor 151, barometric pressure sensor 155, red-green-blue (RGB) color sensor 152, ultra-violet (UV) sensor 153, proximity sensor 167, near field communication (NFC) 169, and/or Global Positioning Sensor (GPS) 160. Mobile device 100 may also include a microphone 165, camera 170, and a wireless subsystem 115 (Bluetooth 166, WiFi 111, cellular receiver 161). In some embodiments, multiple cameras are integrated or accessible to the device. For example, mobile device 100 may have at least a front and rear mounted camera. In some embodiments, other sensors may also have multiple installations or versions.

Memory 105 may be coupled to processor 101 to store instructions for execution by processor 101. In some embodiments, memory 105 is non-transitory. Memory 105 may also store one or more models or modules to implement embodiments described below. Thus, the memory 105 is a processor-readable memory and/or a computer-readable memory that stores software code (programming code, instructions, etc.) configured to cause the processor 101 to perform the functions described. Alternatively, one or more functions of device 100 may be performed in whole or in part in hardware. Memory 105 may also store data from integrated or external sensors.

Network interface 110 may also be coupled to a number of wireless subsystems 115 (e.g., Bluetooth 166, WiFi 111, Cellular 161, or other networks) to transmit and receive data streams through a wireless link to/from a wireless network, or may be a wired interface for direct connection to networks (e.g., the Internet, Ethernet, or other wireless systems). The mobile device may include one or more local area network transceivers connected to one or more antennas. The local area network transceiver comprises suitable devices, hardware, and/or software for communicating with and/or detecting signals to/from WAPs, and/or directly with other wireless devices within a network. In one aspect, the local area network transceiver may comprise a WiFi (802.11x) communication system suitable for communicating with one or more wireless access points.

In addition, wireless subsystem 115 may store application program interfaces (APIs) for accessing places of relevance (POR) determinations. Thus, in some embodiments, POR functionality can be implemented within the wireless subsystem 115 for a low-power implementation. In other embodiments, POR functionality can be implemented as a module separate from other elements in mobile device 100. In yet another example, the POR module 171 may be wholly or partially implemented by other elements illustrated in FIG. 1, for example in the processor 101 and/or memory 105, or in one or more other elements of mobile device 100. Additional details regarding implementation of POR functionality are described below.

Mobile device 100 may also include one or more wide area network transceiver(s) that may be connected to one or more antennas. For example, antenna 102 is coupled to cellular subsystem 161 for receiving cellular network signals from one or more base stations of a cellular network. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 4G, or GSM. Additionally, any other type of wireless networking technologies may be used, for example, WiMax (802.16), Ultra Wide Band, ZigBee, wireless USB, etc.

Mobile device 100 may be any wireless device, cell phone, personal digital assistant, mobile computer, wearable device (e.g., head mounted display, virtual reality glasses, etc.), tablet, personal computer, laptop computer, or any type of device that has processing capabilities. As used herein, “mobile device” may be any portable, or movable device or machine that is configurable to acquire wireless signals transmitted from, and transmit wireless signals to, one or more wireless communication devices or networks. Thus, by way of example but not limitation, mobile device 100 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 100. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above can also be considered a “mobile device” as used herein. Other uses may also be possible. While various examples given in the description below relate to mobile devices, the techniques described herein can be applied to any device for which accurate context inference is desirable.

Mobile device 100 may communicate wirelessly with a plurality of wireless access points (WAPs) using RF signals (e.g., 2.4 GHz, 3.6 GHz, and 4.9/5.0 GHz bands) and standardized protocols for the modulation of the RF signals and the exchanging of information packets (e.g., IEEE 802.11x).

It should be appreciated that embodiments of the invention as will be hereinafter described may be implemented through the execution of instructions, for example as stored in the memory 105 or other element, by processor 101 of device and/or other circuitry of device and/or other devices. Particularly, circuitry of device, including but not limited to processor 101, may operate under the control of a program, routine, or the execution of instructions to execute methods or processes in accordance with embodiments of the invention. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by device itself and/or some or all of the functions, engines or modules described herein may be performed by another system connected through I/O controller 125 or network interface 110 (wirelessly or wired) to device. Thus, some and/or all of the functions may be performed by another system and the results or intermediate calculations may be transferred back to device. In some embodiments, such other device may comprise a server configured to process information in real time or near real time. In some embodiments, the other device is configured to predetermine the results, for example based on a known configuration of the device. Further, one or more of the elements illustrated in FIG. 1 may be omitted from mobile device 100. For example, one or more of the sensors (e.g., sensors 130-165) may be omitted in some embodiments.

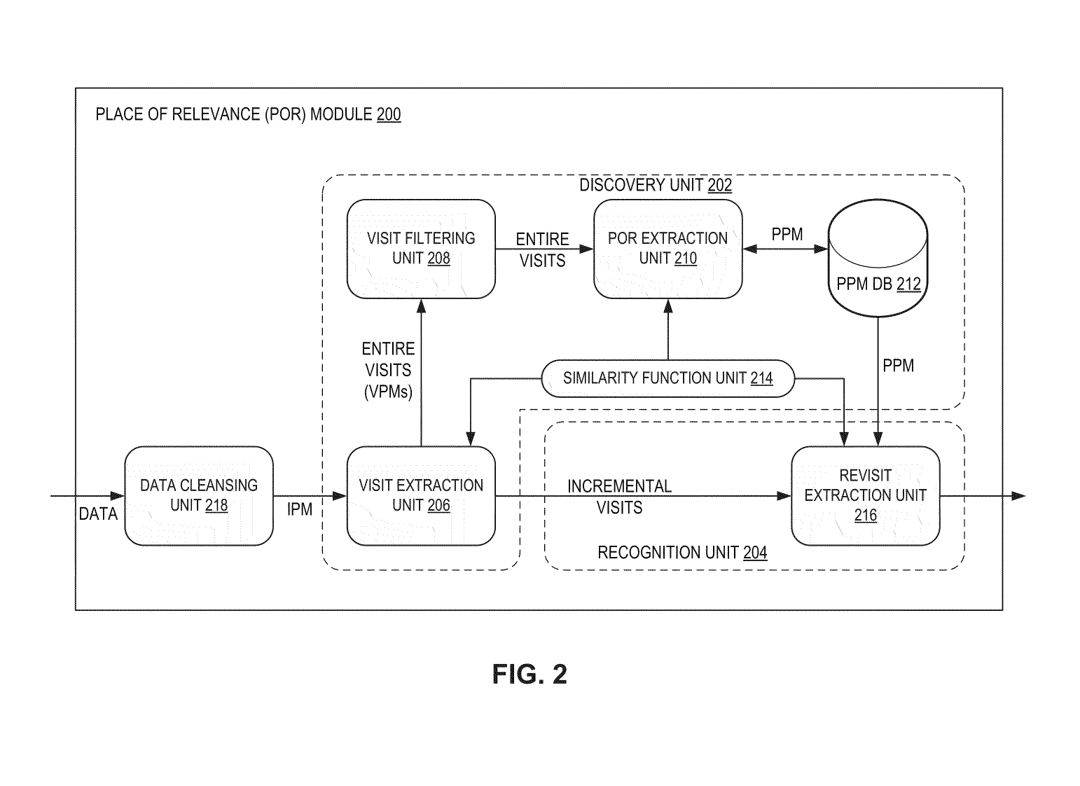

FIG. 2 is a functional block diagram of a place of relevance (POR) module 200 for use in a mobile device. POR module 200 is one possible implementation of POR module 171 of FIG. 1. POR module 200 is illustrated as including a discovery unit 202 and a recognition unit 204. Discovery unit 202 is shown as including a visit extraction unit 206, a visit filtering unit 208, a POR extraction unit 210, a POR place model (PPM) database (DB) 212, and a similarity function unit 214. Recognition unit 204 is shown as including a revisit extraction unit 216. Also shown in FIG. 2 is an optional data cleansing unit 218. In one embodiment, the functions of data cleansing unit 218 are performed by other modules of the mobile device (e.g., processor 101) and thus may not be necessarily included in POR module 200.

Discovery unit 202 identifies new places of relevance (PORs) in an unsupervised manner solely by analyzing a stream of raw data. Discovery unit 202 cannot assume any preexisting knowledge regarding the location of a place of relevance or the size of its spatial expansion. Moreover, the incoming data is not segmented or annotated in any way and a ground truth regarding places and visits is not available. Thus, the discovery of PORs by discovery unit 202 may be solely based on the raw data stream (e.g., DATA input to data cleansing unit 218). The output of discovery unit 202 is a set of PORs with their associated POR place models (PPMs). As shown in FIG. 2, these PPMs are stored in PPM database 212.

Recognition unit 204 identifies whether a revisit to an already known POR occurs. The input to recognition unit 204 is a set of PORs represented by their POR place models and a stream of raw data. Recognition unit 204 analyzes the stream of data utilizing the provided set of place models to determine if a POR is currently revisited and which POR it is. Furthermore, recognition unit 204 may generate an optional confidence value reflecting the confidence level of the recognition decision.

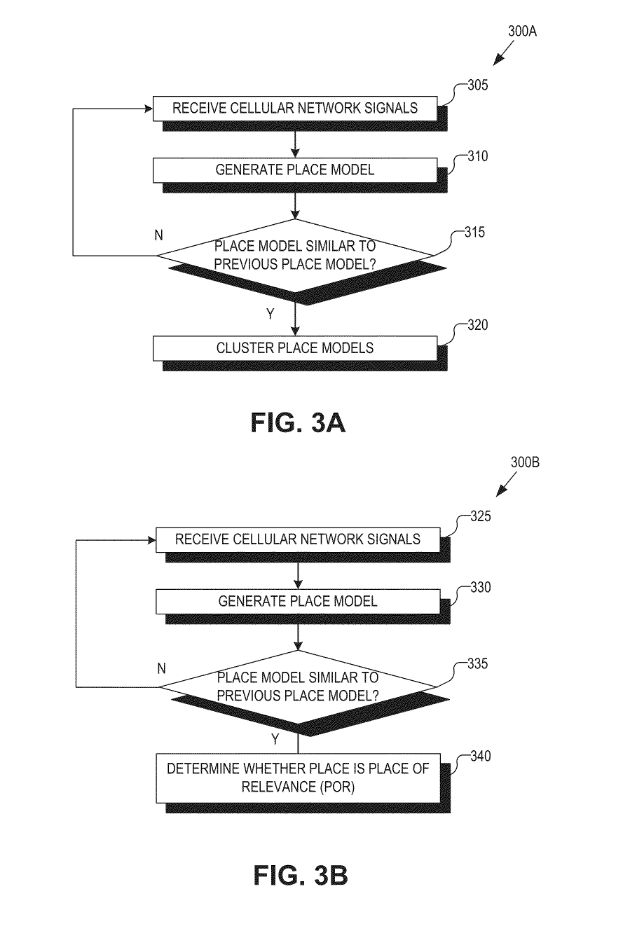

FIG. 3A is a flowchart illustrating a process 300A of building a database of clustered place models for use in a system of determining places of relevance (POR). In one example, process 300A in one possible implementation of building PPM database 212 of FIG. 2. Process 300A begins at process block 305 which includes a cellular subsystem (e.g., cellular subsystem 161) receiving several cellular network signals. As will be discussed in more detail below, relevant information may then be obtained from the received cellular network signals, such as base station identifiers and a corresponding signal strength indicators (e.g., RSSI). Next, in process block 310 one or more place models may be generated. In one aspect, the generated place models may include one or more instantaneous place models, visit place models, and/or place of relevance place models (PPM). In decision block 315, the mobile device then determines whether the place model is similar to one or more previously generated place models (e.g., by way of similarity function unit 214 of FIG. 2). If the place model is indeed similar to one or more previous place models, then process 300A may proceed to process block 320 where the current place model is clustered together with the previously generated and similar place models. As will be discussed in more detail below, if there are no similar place models in the database determined in decision block 315, the current place model may still be added to the database, but no clustering is completed. Process 300A may then return to process block 305 to receive the next cellular network signals.

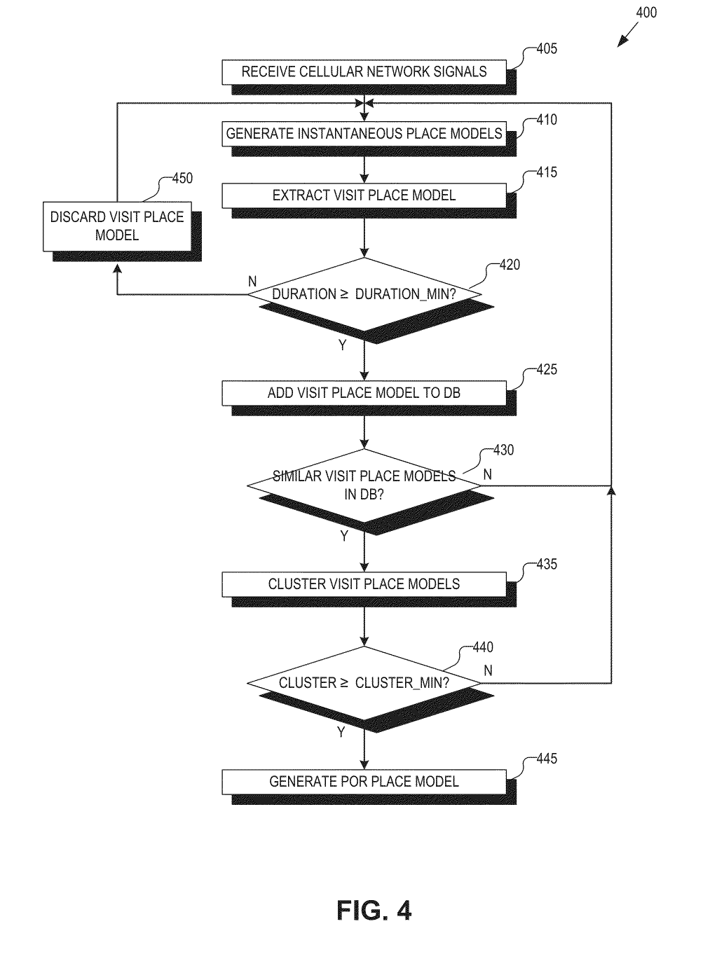

FIG. 3B is a flowchart illustrating a process 300B of determining whether a current place of a mobile device is a place of relevance. Process and decision blocks 325, 330, and 335 are similar to process and decision blocks 305, 310, and 315, described above. However, if it is determined in decision block 335 that the generated place model is indeed similar to previously generated place models, then process block 340 determines whether the current place of the mobile device is indeed a place of relevance. In one aspect, the mobile device determines that the current place of the mobile device is a place of relevance if a clustering of place models similar to the current place model includes at least a minimum number of place models in the clustering. Further details of creating and updating a database of clustered place models, as well as of determining places of relevance will be described in further detail below with reference to process 400 of FIG. 4.

FIG. 4 is a flowchart illustrating a process 400 of building/updating a database of clustered place models and of determining whether a current place of a mobile device is a place of relevance. Process 400 is one possible implementation of both processes 300A and 300B of FIGS. 3A and 3B, respectively. Process 400 will be described with reference to FIGS. 1, 2, and 4. Process 400 begins at process block 405 which includes a cellular subsystem (e.g., cellular subsystem 161) receiving several cellular network signals. Relevant information may then be obtained from the received cellular network signals. In one embodiment, the relevant information includes an identifier (e.g., PCI) of the base stations from which each cellular network signal originated and a corresponding signal strength (e.g., RSSI). However, as mentioned above, base station IDs and RSSI information may already be available within the cellular subsystem 161 without the need to initiate an additional scan of available signals. In one embodiment, the mobile device is configured to update available base station IDs and RSSI information almost once every second for purposes other than the POR determinations discussed herein. Thus, in this embodiment, process 400 may obtain data for POR determinations essentially for “free” in terms of power consumption, since the mobile device is already obtaining such information. In one example, the data used by process 400 to determine whether a current position is a POR is based solely on the base station IDs and corresponding RSSI information.

Next, in process block 410, data cleansing unit 218 generates instantaneous place models (IPMs) based on the data collected (e.g., base station ID and RSSI). In one embodiment, the data cleansing unit 218 may generate the IPMs based on an average RSSI value and the Response Rate (RR) for each base station ID. The average RSSI value may represent the average distance from a base station. Process 400 may utilize the distances to all base stations to characterize the current position of the mobile device in a similar way as the centroid of the place. In one embodiment, data cleansing unit 218 removes a cell tower from distance computation if the cell tower's corresponding RR is too low. Similarly, if an RSS value is too low, data cleansing unit 218 can exclude that cell tower as well in distance computation.

As shown in FIG. 2, the generated IPMs are then passed to the visit extraction unit 206. Process block 415, of process 400, represents the extraction of visit place models (VPMs) by visit extraction unit 216. In one embodiment, VPMs represent a duration of time that the mobile device remains continuously at its current position, as defined by the modeled characteristic. The extraction of VPMs is based on temporal clustering of IPMs in combination with outlier removal.

In general, temporal clustering by visit extraction unit 206 includes mapping data points into a one-dimensional space of time. This clustering technique finds its origin from linear clustering, a clustering technique used in database index theory where multi-dimensional data is mapped into a one-dimensional space (table). This idea is used in process block 415 to perform clustering along the time dimension. Conceptually, temporal clustering is done such that the following constraints hold: Two data points are clustered into the same cluster if and only if they share sufficient similarity (with respect to a similarity function and a similarity threshold) and if all of the data points between them (with respect to time) are also assigned to this cluster. As a result, a cluster represents an interval of time where all data points over the duration of the interval share at least a certain similarity. Hence in this domain the interval constitutes a visit.

By way of example, data points may be evaluated in temporal order whether or not they are similar to the current cluster. Given that the data point is similar enough, the cluster is updated by the data point. If the data point is not similar enough a new cluster is formed.

As mentioned above, visit extraction unit 206 may also perform outlier removal. A challenge with outlier data points is that they cause the temporal clustering to introduce artificial splits in visits. This is caused as outliers don't share enough similarity with their direct neighbors (neighbors in the dimension of time).

To perform outlier removal, visit extraction unit 206 may combine any two visits if and only if their similarity is smaller than a similarity threshold and if the time gap between them is less than time threshold. As a result visits which have been previously split due to outliers may be fused together into a single visit. For example, comparison of a first visit to a second visit may reveal the two visits are too dissimilar, which initially split the visit. However, if the first and a third visit are both similar enough both in time and feature space then the two are combined into a single VPM.

Next, in decision block 420, visit filtering unit 208 determines whether the VPM has a duration of time that exceeds a minimum duration of time threshold. As mentioned above, PORs are based on visits which exceed a minimum duration of time threshold. Therefore visits are filtered based on their duration such that all remaining visits exceed the minimum duration of time threshold. For example, during a commute an individual data point often results in very short visits due to their dissimilarity to neighboring data points with respect to the time dimension. VPMs whose duration does not exceed the minimum duration of time threshold are discarded, as shown in process block 450.

Those VPMs whose duration does indeed exceed the minimum duration of time threshold are then saved to the PPM database 212 (i.e., process block 425). Next, in decision block 430, POR extraction unit 210 attempts to cluster the current VPM with previously extracted VPMs. In one aspect, clustering the visit place model with previously extracted visit place models includes determining whether the current visit place model is similar to a previously extracted visit place model based on the similarity function provided by similarity function unit 214.

Similarity function unit 214 provides a similarity function that determines whether or not two place models represent the same place. Each similarity function is normalized between 0 and 1, where 0 indicates no similarity and 1 indicates maximal similarity. In one embodiment, a Tanimoto similarity function is utilized by similarity function unit 214. The Tanimoto function measures the similarity between two feature vectors (fᵥₐ and f_{vb}) according to equation 1, as below:

$$Tanimoto ( {fv}_{a} , {fv}_{b} ) = \frac{{fv}_{a} \cdot {fv}_{b}}{{‖ {fv}_{a} ‖}^{2} + {‖ {fv}_{b} ‖}^{2} - {fv}_{a} \cdot {fv}_{b}} ∈ [ 0 , 1 ] , \qquad EQ ( 1 )$$

where the feature vectors fᵥₐ and f_{vb} are derived from the base station RSSI values of a place model. Given place model pmₓ of place x, rssi_{x,j}^{avg} denotes the average RSSI value of access point apᵢ (i.e., base station). Then, the Tanimoto similarity is calculated according to equation 2, as below:

$${f}_{sim}^{tanimoto} ( {pm}_{a} , {pm}_{b} ) = \frac{{\sum }_{i = 1}^{n} {x}_{a , i} \cdot {x}_{b , i}}{{\sum }_{i = 1}^{n} {x}_{a , i}^{2} + {\sum }_{i = 1}^{n} {x}_{b , i}^{2} - {\sum }_{i = 1}^{n} {x}_{a , i} \cdot {x}_{b , i}} , \qquad EQ ( 2 )$$

where x_{a,i}=rssi_{a,i}^{avg}+101. Note that the RSSI value is transformed from a space of [−101, 0] to a space of [0, 101] in order to make the length of each feature zero when the RSSI value is −101. Given that an AP apᵢ is only contained in one of the two place models, similarity function unit 214 adds it to the other place models pmᵤ and sets the RSSI value to a minimum RSS value of the respective base station (e.g., rssi_{a,j}^{avg}=−101).

One concept of the Tanimoto function is that more overlap in feature space indicates more similarity. In the formula above, the nominator value increases with more overlap between fᵥₐ and f_{vb} in the feature space. The denominator is to normalize the output values between 0 and 1. For example, if fᵥₐ and f_{vb} are exclusive (totally different APs), then

$$\frac{{fv}_{a} \cdot {fv}_{b}}{{‖ {fv}_{a} ‖}^{2} + {‖ {fv}_{b} ‖}^{2} - {fv}_{a} \cdot {fv}_{b}} = \frac{0}{{‖ {fv}_{a} ‖}^{2} + {‖ {fv}_{b} ‖}^{2} - 0} = 0$$

If, however, fᵥₐ and f_{vb} were identical in terms of their APs and the average RSSI values, then

$$\frac{{fv}_{a} \cdot {fv}_{b}}{{‖ {fv}_{a} ‖}^{2} + {‖ {fv}_{b} ‖}^{2} - {fv}_{a} \cdot {fv}_{b}} = \frac{{fv}_{a} \cdot {fv}_{a}}{{‖ {fv}_{a} ‖}^{2} + {‖ {fv}_{a} ‖}^{2} - {fv}_{a} \cdot {fv}_{a}} = \frac{{‖ {fv}_{a} ‖}^{2}}{{‖ {fv}_{a} ‖}^{2} + {‖ {fv}_{a} ‖}^{2} - {‖ {fv}_{a} ‖}^{2}} = 1$$

If fᵥₐ and f_{vb} overlap to some extent, then the similarity is between 0 and 1 (less overlap closer to 0, more overlaps closer to 1). Although the Tanimoto similarity function is described above with reference to similarity function unit 214, other known similarity functions may be implemented in accordance with the teachings of the present disclosure. For example, Hamming, Euclidean, Jaccard, Dice, and Cosine similarity functions may also be used.

Beyond the RSSI value, similarity function unit 214 may use the Response Rate (RR) as a statistical feature for place models. The RR is derived over time from multiple cellular signal scans and represents the frequency ratio of a AP (i.e., base station) being present. Although all APs are used in building a place model, similarity function unit 214 can use this feature to filter out infrequently observed APs during the similarity computation. Infrequently observed APs are often less informative or even destructive to a similarity measurement. Instead of directly applying a threshold on the response rate of APs, similarity function unit 214 may derive the relative Response Rate fᵣᵣ^{rel}(apᵢ) corresponding to AP apᵢ according to equation 3, as below:

$${f}_{rr}^{rel} ( {ap}_{i} , {pm}_{k} , {pm}_{h} ) = \frac{max ( {f}_{rc} ( {ap}_{i} , {pm}_{k} ) + {f}_{rc} ( {ap}_{i} , {pm}_{h} ) )}{max ( \begin{matrix}{max}_{{ap}_{j} {ε pm}_{k}} {f}_{rc} ( {ap}_{j} , {pm}_{k} ) + \\ {max}_{{ap}_{j} {ε pm}_{h}} {f}_{rc} ( {ap}_{j} , {pm}_{h} )\end{matrix} )} , \qquad EQ ( 3 )$$

where f_{rc}(apᵢ,pmₖ) is the response count of AP apᵢ. Similarity function unit 214 utilizes the relative response rate to normalize the response rate with the maximum response count in a given place. This normalization is useful in places where cellular radio conditions are unstable and thus all response rates of observed APs are low.

Returning now to process 400 of FIG. 4, process block 435 includes clustering the current VPM with similar previously extracted VPMs. In one embodiment, similarity function unit 214 includes a similarity threshold to perform a recursive similarity clustering. This clustering approach assumes that the number of clusters is not given, but a threshold is given. The number of clusters is driven by the data. The advantage of this approach is that clusters can be dynamically added without rerunning the entire clustering process. Conceptually, a VPM is assigned to the most similar cluster, but only if the similarity is not higher than the similarity threshold. In the case where the similarity exceeds the similarity threshold a new cluster is formed. The clustering process terminates if cluster assignments reach a fixed point.

Once the similarity clustering has terminated all clusters are analyzed whether or not they qualify as a POR. Clusters which contain at least a threshold number of VPMs represent a POR (i.e., decision block 440). The POR model is then generated by labeling the respective cluster in the PPM database 212 in process block 445. The generation of the POR model may include labeling of clustered VPMs stored in PPM database 212 as a PPM.

As discussed above, embodiments of the present disclosure may further provide for determining whether the current position of the mobile device is a revisit to a previously determined POR. For example, with reference to FIG. 2, recognition unit 204 is configured to detect such revisits. A revisit occurs if a user returns to a place which was previously discovered as POR. Note that a revisit occurs if a user visits a POR independent of how much time is spend at this POR. In one embodiment, the input to revisit extraction unit 216 is an instantaneous place model representing the current location of the user. This instantaneous place model is derived from one or more raw data points collected at the current location, e.g. multiple samples collected within a very short time frame. Utilizing the similarity function unit 214 and based on this instantaneous place model, the revisit extraction unit 216 recognizes if a revisit occurs.

However, in the illustrated embodiment of FIG. 2, an additional output of the visit extraction unit 206 (temporal clustering and merging) may be utilized. That is, the visit extraction unit 206 may be configured such that it outputs the current VPM at each time step instead of outputting VPMs only after the visit has been completed. The revisit extraction unit 216 maintains an internal state variable which can be in one of two states: “enter” or “exit”. The internal state “enter” indicates an ongoing revisit and “exit” that no revisit is recognized (or the previous revisit has ended and no new revisit has started). Recognition unit 204 transitions from state “exit” to “enter” if two conditions hold true: (1) the ongoing visit has to exceed an enter recognition time threshold and (2) by similarity the visit has to be identified as a visit to a known POR. The recognition unit 204 monitors the intermediate results of the visit extraction unit 206 and once the two conditions become true a revisit has been detected. Once the recognition unit 204 transitions into state “enter” it reports the revisit by returning the identifier of the POR at each recognition step. After the transition occurred and the system is in state “enter”, it monitors the VPM that caused the transition. Given there are no outliers and the user stays at the same location, the monitored visit grows in time with each recognition step. The revisits ends if the time duration of the monitored visit exceeds an exit recognition time threshold. This prevents the system to drop in and out based on outliers. For instance, if the current data point would be an outlier the recognition unit 204 should not output −1 indicating no revisit. The stateful system will tolerate this outlier and report the POR indicator as long as the time duration to the monitored visit doesn't exceed exit recognition time threshold. The enter and exit time thresholds introduce an intrinsic tradeoff between latency and accuracy. The larger the time thresholds the lower is the chance of misclassification due to an outlier, however, the entry and exit of a revisit will be detected with an increased latency.

As mentioned above, recognition unit 204 may be configured to additionally generate a confidence value. The confidence value may be representative of a confidence in the recognition decision. The confidence value computation is based on the difference between two most similar places according to equation 4, below

$$C ( {pm}_{v} , {pm}_{1} , {pm}_{2} ) = \frac{{f}_{sim} ( {pm}_{1} , {pm}_{v} ) - {f}_{sim} ( {pm}_{2} , {pm}_{v} )}{{f}_{sim} ( {pm}_{1} , {pm}_{v} ) + {f}_{sim} ( {pm}_{2} , {pm}_{v} )} , \qquad EQ ( 4 )$$

where pm₁ and pm₂ are the POR place models of the two most similar PORs and pmᵥ is the visit place model of the monitored visit.

Various modifications to the embodiments disclosed herein will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method, comprising:
receiving cellular network signals from a plurality of cells of a cellular network at a mobile device that is located at a place within the cellular network;
generating a place model representative of a characteristic of the place where the mobile device is located in response to the received cellular network signals; and
clustering the place model with one or more previously generated place models if the place model is similar to the one or more previously generated place models.

2. The method of claim 1, further comprising determining whether the place where the mobile device is located is a place of relevance to a user based on the clustering of place models.

3. The method of claim 2, wherein determining whether the place is a place of relevance to the user includes determining whether the clustering of place models contains at least a threshold number of place models, and if so, generating a place of relevance place model representative of the clustering of place models that indicates that the place is a place of relevance.

4. The method of claim 1, wherein generating the place model includes:
generating an instantaneous place model representative of the characteristic of the place in response to information obtained from the received cellular network signals; and
extracting a visit place model representative of a duration of time that the mobile device remains continuously at the place in response to the generated instantaneous place model, wherein clustering the place model includes clustering the visit place model with previously extracted visit place models if the visit place model has a duration of time that exceeds a minimum duration of time threshold.

5. The method of claim 4, wherein clustering the visit place model with previously extracted visit place models includes determining whether the visit place model is similar to a previously extracted visit place model, and wherein the visit place model is similar to the previously extracted visit place model if the duration of time of the visit place model is within a threshold amount of the duration of time of the previously extracted visit place model.

6. The method of claim 4, wherein the information obtained from the received cellular network signals includes identifiers of base stations from which the cellular network signals originated and corresponding received signal strength indicators (RSSIs) of each received cellular network signal.

7. The method of claim 6, wherein the identifiers of the base stations includes physical cell IDs (PCIs).

8. The method of claim 6, wherein the information obtained from the received cellular network signals to generate the instantaneous place models consists only of the base station identifiers and the RSSIs.

9. A mobile device, comprising:
a receiver configured to receive cellular network signals from a plurality of cells of a cellular network while the mobile device is located at a place within the cellular network;
a memory; and
a processing unit coupled to the memory and configured to:
generate a place model representative of a characteristic of the place where the mobile device is located in response to the received cellular network signals; and
cluster the place model with one or more previously generated place models if the place model is similar to the one or more previously generated place models.

10. The mobile device of claim 9, wherein the mobile device is further configured to determine whether the place where the mobile device is located is a place of relevance to a user based on the clustering of place models.

11. The mobile device of claim 10, wherein the processing unit is further configured to generate a place of relevance place model representative of the clustering of place models that indicates that the place is a place of relevance if the clustering of place models contains at least a threshold number of place models.

12. The mobile device of claim 9, wherein the processing unit is further configured to:
generate an instantaneous place model representative of the characteristic of the place in response to information obtained from the received cellular network signals; and
extract a visit place model representative of a duration of time that the mobile device remains continuously at the place in response to the generated instantaneous place model, wherein clustering the place model includes clustering the visit place model with previously extracted visit place models if the visit place model has a duration of time that exceeds a minimum duration of time threshold.

13. The mobile device of claim 12, wherein the processing unit is further configured to cluster the visit place model with previously extracted visit place models if the visit place model is similar to a previously extracted visit place model, and wherein the visit place model is similar to the previously extracted visit place model if the duration of time of the visit place model is within a threshold amount of the duration of time of the previously extracted visit place model.

14. The mobile device of claim 12, wherein the information obtained from the received cellular network signals includes identifiers of base stations from which the cellular network signals originated and corresponding received signal strength indicators (RSSIs) of each received cellular network signal.

15. The mobile device of claim 14, wherein the identifiers of the base stations includes physical cell IDs (PCIs).

16. The mobile device of claim 14, wherein the information obtained from the received cellular network signals to generate the instantaneous place models consists only of the base station identifiers and the RSSIs.

17. A computer-implemented method, comprising:
receiving cellular network signals from a plurality of cells of a cellular network at a mobile device that is located at a place within the cellular network;
generating a place model representative of a characteristic of the place where the mobile device is located in response to the received cellular network signals; and
determining whether the place where the mobile device is located is a place of relevance to a user based on a clustering of one or more previously generated place models if the place model is similar to the one or more previously generated place models.

18. The method of claim 17, wherein determining whether the place is a place of relevance to the user includes generating a place of relevance place model representative of the clustering of place models that indicates that the place is a place of relevance if the clustering of place models contains at least a threshold number of place models.

19. The method of claim 17, wherein generating the place model includes:
generating an instantaneous place model representative of the characteristic of the place in response to information obtained from the received cellular network signals; and
extracting a visit place model representative of a duration of time that the mobile device remains continuously at the place in response to the generated instantaneous place model, wherein the place model is similar to the previously extracted place model if the duration of time of the visit place model is within a threshold amount of the duration of time of previously extracted visit place models.

20. The method of claim 19, wherein the information obtained from the received cellular network signals includes identifiers of base stations from which the cellular network signals originated and corresponding received signal strength indicators (RSSIs) of each received cellular network signal.

21. The method of claim 20, wherein the identifiers of the base stations includes physical cell IDs (PCIs).

22. The method of claim 20, wherein the information obtained from the received cellular network signals to generate the instantaneous place models consists only of the base station identifiers and the RSSIs.

23. A mobile device, comprising:
a receiver configured to receive cellular network signals from a plurality of cells of a cellular network while the mobile device is located at a place within the cellular network;
memory; and
a processing unit coupled to the memory and configured to:
generate a place model representative of a characteristic of the place where the mobile device is located in response to the received cellular network signals; and
determine whether the place where the mobile device is located is a place of relevance to a user based on a clustering of one or more previously generated place models if the place model is similar to the one or more previously generated place models.

24. The mobile device of claim 23, wherein the processing unit is further configured to generate a place of relevance place model representative of the clustering of place models that indicates that the place is a place of relevance if the clustering of place models contains at least a threshold number of place models.

25. The mobile device of claim 24, wherein the processing unit is further configured to:
generate an instantaneous place model representative of the characteristic of the place in response to information obtained from the received cellular network signals; and
extract a visit place model representative of a duration of time that the mobile device remains continuously at the place in response to the generated instantaneous place model, wherein the place model is similar to the previously extracted place model if the duration of time of the visit place model is within a threshold amount of the duration of time of previously extracted visit place models.

26. The mobile device of claim 25, wherein the information obtained from the received cellular network signals includes identifiers of base stations from which the cellular network signals originated and corresponding received signal strength indicators (RSSIs) of each received cellular network signal.

27. The mobile device of claim 26, wherein the identifiers of the base stations includes physical cell IDs (PCIs).

28. The mobile device of claim 25, wherein the information obtained from the received cellular network signals to generate the instantaneous place models consists only of the base station identifiers and the RSSIs.
